(19) United States
(12) Patent Application Publication
(10) Pub. No.: US 2011/0234616 A1
(43) Pub. Date: Sep. 29, 2011

(54) PROJECTOR SYSTEM AND OPERATION METHOD THEREOF

(76) Inventor: Chun-Cheng Lee, Kouhu Township (TW)

(21) Appl. No.: 13/071,098

(22) Filed: Mar. 24, 2011

(30) Foreign Application Priority Data
Mar. 26, 2010 (TW) 99109146

(51) Int. Cl. G09G 5/02

(52) U.S. Cl. 345/589

(57) ABSTRACT

This invention discloses a projector system includes a memory, a projecting unit, an image reading unit and an image analysis unit. The memory stores LUTs corresponding to different background planes respectively. Each LUT is related to an HSI value, Hue, Saturation and Intensity, of a corresponding background plane. The projecting unit projects an image on a background plane. The image reading unit gathers a data of the background plane. The image analysis unit analyzes the data to find out an HSI value of the background plane. The image analysis unit searches the memory to find a corresponding LUT according to the HSI value of the background plane and amend the image projected on the background plane according to the corresponding LUT.

### RELATED APPLICATIONS

This application claims priority to Taiwan Application Serial Number 99109146, filed Mar. 26, 2010, which is herein incorporated by reference.

### BACKGROUND

1. Field of Invention

The present invention relates to a projector system. More particularly, the present invention relates to a projector system that can dynamically adjust the color according to the projecting background.

2. Description of Related Art

Projector has been widely used in many kinds of activity, such as in teaching activity or in home activity, for projecting images on a background plane.

A micro-projector is embedded in a portable device. The micro-projector is directly connected to a computer to project the image displayed in the computer on a background plane. However, the color of the projected image is affected by the color of the background plane. For example, if the color of the background plane deflects to red color, the image projected on the background plane will also deflect to red color. Although the above problem can be resolved by replacing the background plane with a background plane with white color, it is not easy to find a perfect background plane. Further, the main invention purpose of the micro-projector is to project images in anytime and in anywhere. Therefore, the limitation of the background plane will destroy the main purpose of the micro-projector.

Therefore, a projector system that can adjust the image according to the background plane is required.

### SUMMARY

This invention discloses a projector system includes a memory, a projecting unit, an image reading unit and an image analysis unit. The memory stores LUTs corresponding to different background planes respectively. Each to LUT is related to an HSI value, Hue, Saturation and Intensity, of a corresponding background plane. The projecting unit projects an image on a background plane. The image reading unit gathers a data of the background plane. The image analysis unit analyzes the data to find out an HSI value of the background plane. The image analysis unit searches the memory to find a corresponding LUT according to the HSI value of the background plane and amend the image projected on the background plane according to the corresponding LUT.

In an embodiment, the LUTs are got by detecting HSI values of background planes, and comparing the detected HSI values with a standard HSI value, wherein the standard HSI value is an HSI value of a background plane with a white color.

In an embodiment, the projector system further comprises an Interface to select one of the LUTs.

This invention further discloses a projecting method. The method includes to detect HSI values of background planes. Then, the LUTs corresponding to the background planes respectively are formed. Each LUT is related to an HSI value, Hue, Saturation and Intensity, of a corresponding background plane. Then, a data of a background plane is gathered. The data is analyzed to find out an HSI value of the background plane. Next, a corresponding LUT is searched according to the HSI value of the background plane. Finally, the image projected on the background plane is amended according to the corresponding LUT.

Accordingly, the HSI value, Hue, Saturation and Intensity, of the image signal projected on a background plane can be adjusted according to the background plane. Therefore, even though the background plane is not white color, the color of the image projected on the background plane is similar to the color of the image projected on a white color background plane.

### BRIEF DESCRIPTION OF THE DRAWINGS

The invention can be more fully understood by reading the following detailed description of the embodiments, with reference made to the accompanying drawings as follows:

FIG. 1 illustrates an HIS color space.

FIG. 2 illustrates a schematic diagram of a projector system of the present invention.

FIG. 3 illustrates a flow chart to adjust the image signal according to the background plane.

### DETAILED DESCRIPTION

The projector system of this present invention detects the usage environment before projecting. That is, the projector system detects the HSI value, Hue, Saturation and Intensity, of a background plane, such as a first background plane, first. Then, the detected HSI value is compared with a standard HSI value, such as an HSI value of a background plane with white color. The compared result is used to build a look up table, LUT. When the projector system projects an image on the first background plane, the projector system can use this LUT to adjust the HSI value of this image to compensate the HSI value of the first background plane. Therefore, even though the first background plane is not white color, the color of the image projected on the first background plane is similar to the color of the image projected on a white color background plane. The foregoing detecting process and comparing process are repeated to build a plurality of LUTs corresponding to different background planes. These LUTs are stored in a memory of the projector system. Accordingly, when a user uses this projector system of the present invention to project, this projector system detects the HSI value of the background for projecting first. Then, a corresponding LUT is searched out to adjust the HSI value of this image to compensate the HSI value of the first background plane.

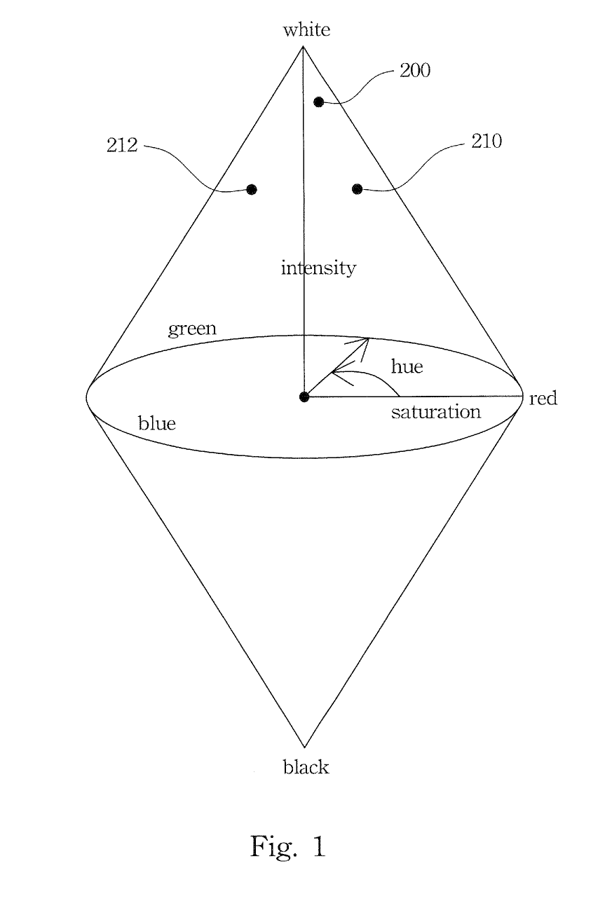

FIG. 1 illustrates an HIS color space. The HSI color space represents colors similarly how the human eye senses colors. The HSI color model represents every color with three components: hue (H), saturation (S), intensity (I). Hue is a distinct color of the spectrum—red, green, yellow, orange, blue, and so on. It is the particular wavelength frequency. Saturation is the “purity” of the color. Saturation refers to the amount of white light mixed with the hue. Pastels are less saturated colors. Fully saturated colors are very rich and bright. Less saturated colors look muddier, or less pure. As saturation decreases, all colors become a value of gray. The intensity of a color is the amount of light or white it contains. Intensity refers to the intensity of light present. When light is at its fullest intensity, colors will become bright, at its least intensity, colors become dim. The Hue component describes the color itself in the form of an angle between [0,360] degrees. 0 degree mean red, 120 degrees means green, 240 degrees means blue, 60 degrees is yellow, and 300 degrees is magenta. The Saturation component signals how much the color is polluted with white color. The range of the S component is [0,255]. The Intensity range is between [0,255].

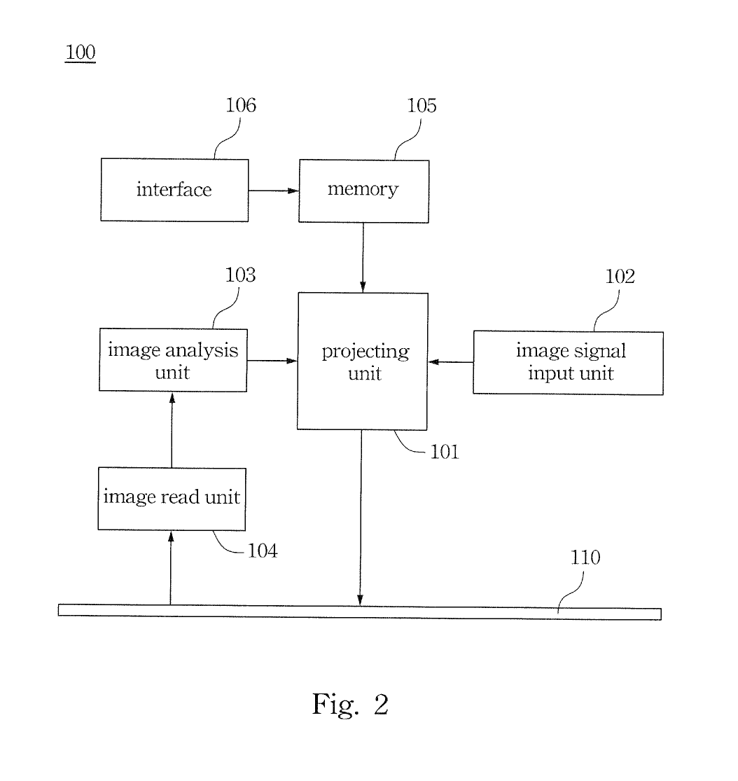

FIG. 2 illustrates a schematic diagram of a projector system of the present invention. The projector system 100 includes a projecting unit 101, an image signal input unit 102, an image analysis unit 103, an image reading unit 104 and a memory 105.

The memory 105 stores LUTs corresponding to different background planes. The projecting unit 101 is a Cathode Ray Tube (CRT) projector, a liquid crystal display (LCD) projector or a DLP projector. In this embodiment, the projecting unit 101 is an LCD projector. To display images, LCD projectors typically send light from a lamp through a prism that separates light to three poly silicon panels—one each for the red, green, and blue components of the video signal. As polarized light passes through the panels (combination of polarizer, LCD panel and analyzer), individual pixels can be opened to allow light to pass or closed to block the light. The combination of open and closed pixels can produce a wide range of colors and shades in the projected image. Then, the color image is projected on the background plane 110 by the projecting unit 101. The projecting unit 101 can be also a micro-projector that is embedded in a portable device. The portable device is a mobile phone, a PDA or a portable computer.

The image reading unit 104 gathers the data of the background plane 110 before the image is projected on the background plane 110 by the projecting unit 101. Next, the data of the background plane 110 is sent to image analysis unit 103 by the image reading unit 104. The image analysis unit 103 analyzes the data to find the HSI value, hue (H), saturation (S), intensity (I), of the background plane 110. Then, the image analysis unit 103 search the memory 105 to find out a corresponding LUT based on the analysis result. The image signal outputted from the image signal input unit 102 to the projecting unit 101 is amended according to the searched out LUT. In an embodiment, the is HSI value, hue (H), saturation (S), intensity (I), of the image signal is amended by the image analysis unit 103 according to the searched out LUT. Then, the amended image signal is sent to the projecting unit 101 to project on the background plane 110. In another embodiment, the HSI value, hue (H), saturation (S), intensity (I), of the image signal is amended by the projecting unit 101 according to the searched out LUT and is projected on the background plane 110. It is noticed that the foregoing amendment process is directly applied to the image signal. Therefore, it is not necessary to reset the hardware of the projecting unit 101. However, in another embodiment, the image signal can keep the original value. The hardware, such as the focus and the diaphragm, of the projecting unit 101 is reset according to the LUT. For example, the focus is adjusted to clear the image projected on the background plane 110. The diaphragm is adjusted to improve the intensity of the image projected on the background plane 110. In further embodiment, the amendment of the image signal and the adjustment of the hardware of the projecting unit 101 can be performed together.

The method to search out a corresponding LUT is described in the following. Please see FIG. 1 again. In an embodiment, a first LUT is used to compensate the HSI value difference between the point 210 and point 200, and a second LUT is used to compensate the HSI value difference between the point 212 and the point 200. Therefore, the first LUT corresponds to the point 210. The second LUT corresponds to the point 212. Accordingly, when the image analysis unit 103 analyzes a data of the background plane 110 and finds the HSI value, hue (H), saturation (S), intensity (I), of the background plane 110. Then, the image analysis unit 103 can find a point located in the coordinate system corresponding to the HSI value. For example, if this searched out point is point 210, the first LUT is used to amend the image signal to make the image projected on the background plane 110 with the point 210 HSI value is similar to the image projected on the background plane with the point 200 HSI value. In another example, if a background plane has a hue value deflected to red color, the red color of this image is decreased to compensate the aberration of the background plane. Moreover, for preventing too many LUTs stored in memory 105, a range is set. That is, the 3D space in FIG. 1 is divided into several blocks based on the set range. Each block corresponds to an LUT. Accordingly, when the image analysis unit 103 analyzes a data of the background plane 110 and finds the HSI value, hue (H), saturation (S), intensity (I), of the background plane 110. Then, the image analysis unit 103 can find a point located in a corresponding block. The LUT corresponding to this block is used to amend the image signal.

In another embodiment, the projector system 100 further includes an Interface 106 with buttons. A user can select an LUT through the Interface 106. In other words, in this embodiment, it is not necessary for the image analysis unit 103 to analysis a data of the background plane 110 to search out an LUT. The user can select an LUT by himself and uses the selected LUT to amend the HSI value of the image signal. However, in another embodiment, the image signal can keep the original value. The hardware, such as the focus and the diaphragm, of the projecting unit 101 is reset according to the selected LUT. For example, the focus is adjusted to clear the image projected on the background plane 110. The diaphragm is adjusted to improve the intensity of the image projected on the background plane 110. In further embodiment, the amendment of the image signal and the adjustment of the hardware of the projecting unit 101 according to the selected LUT can be performed together.

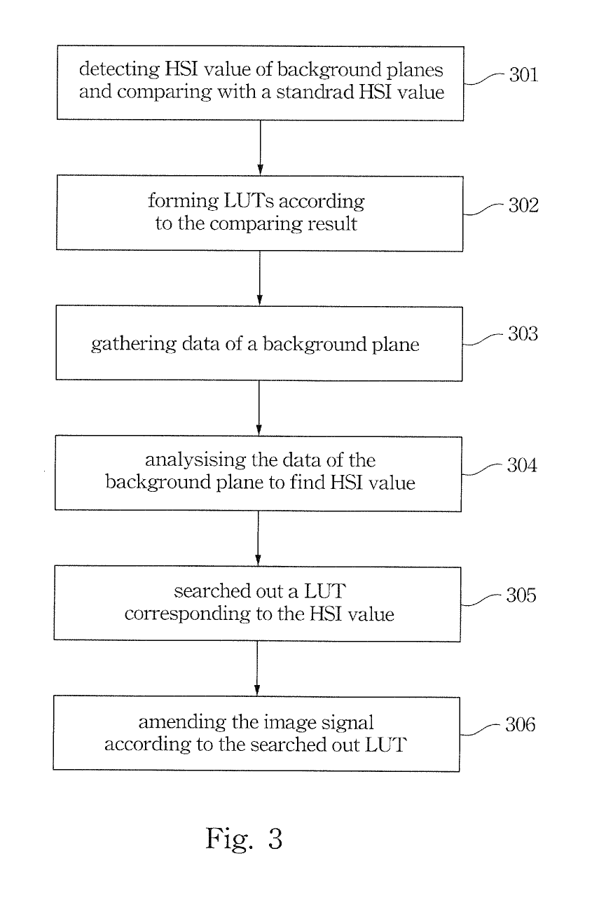

FIG. 3 illustrates a flow chart to adjust the image signal according to the background plane. In step 301, the projector system of this present invention detects the usage environment before projecting. That is, the projector system detects the HSI value, Hue, Saturation and Intensity, of background planes. Then, these detected HSI values are compared with a standard HSI value, such as an HSI value of a background plane with white color, respectively. Then, in step 302, the compared results are used to build LUTs respectively. Each LUT corresponds to an HSI value of a background plane. In step 303, a data of a background plane is gathered when the projector system projects an image on the background plane. In step 304, the data is analyzed to find the HSI value of the background plane. Next, in step 305, a corresponding LUT is searched out based on the analyzed result. Finally, in step 306, the projector system can use this searched out LUT to adjust the HSI value of this image signal projected on the background plane.

Accordingly, the HSI value, Hue, Saturation and Intensity, of the image signal projected on a background plane can be adjusted according to the background plane. Therefore, even though the background plane is not white color, the color of the image projected on the background plane is similar to the color of the image projected on a white color background plane. Moreover, it is not necessary to increase the power to compensate the HSI value of the background plane. Therefore, the power consumption is reduced.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A projector system, comprising:
a memory storing a plurality of LUTs corresponding to different background planes respectively, wherein each LUT is related to an HSI value, Hue, Saturation and Intensity, of a corresponding background plane;
a projecting unit for projecting an image on a background plane;
an image reading unit for gathering a data of the background plane; and
an image analysis unit for analyzing the data to find out an HSI value, Hue, Saturation and Intensity, of the background plane;
wherein the image analysis unit searches the memory to find a corresponding LUT according to the HSI value, Hue, Saturation and Intensity, of the background plane, the image projected on the background plane is amended according to the corresponding LUT.

2. The projector system of claim 1, wherein the LUTs are got by detecting HSI values of background planes, and comparing the detected HSI values with a standard HSI value.

3. The projector system of claim 2, wherein the standard HSI value is a HSI value of a background plane with a white color.

4. The projector system of claim 1, wherein the projector system further comprises an Interface to select one of the LUTs.

5. The projector system of claim 1, wherein the projecting unit is a Cathode Ray Tube (CRT) projector, a liquid crystal display (LCD) projector or a DLP projector.

6. The projector system of claim 1, wherein the projecting unit is a micro-projector that is embedded in a portable device, and the portable device is a mobile phone, a PDA or a portable computer.

7. The projector system of claim 1, wherein the image analysis unit amends the HSI value of the image projected on the background plane according to the corresponding LUT.

8. The projector system of claim 1, wherein the image analysis unit adjust the focus or the diaphragm to change the HSI value of the image projected on the background plane according to the corresponding LUT.

9. A projecting method, comprising:
detecting HSI values of a plurality of background planes;
forming a plurality of LUTs corresponding to the background planes respectively, wherein each LUT is related to an HSI value, Hue, Saturation and Intensity, of a corresponding background plane;
gathering a data of a background plane;
analyzing the data to find out an HSI value, Hue, Saturation and Intensity, of the background plane;
searching a corresponding LUT according to the HSI value, Hue, Saturation and Intensity, of the background plane; and
amending the image projected on the background plane according to the corresponding LUT.

10. The projecting method of claim 9, wherein the LUTs are got by detecting HSI values of background planes, and comparing the detected HSI values with a standard HSI value.

11. The projecting method of claim 10, wherein the standard HSI value is an HSI value of a background plane with a white color.

12. The projecting method of claim 9, wherein amending the image is to amend the HSI value of the image projected on the background plane according to the corresponding LUT.

13. The projecting method of claim 9, wherein amending the image is to adjust the focus or the diaphragm to change the HSI value of the image projected on the background plane according to the corresponding LUT.
